(19) United States
(12) Patent Application Publication
(10) Pub. No.: US 2007/0187650 A1
(43) Pub. Date: Aug. 16, 2007

(54) Antioxidant for an organic material and method for treating the same

(75) Inventors: Manfred Anders, Leipzig (DE); Dirk Andreas Lichtblau, Halle/Saale (DE); Jana Kolar, Ivanena Gorica (SI); Jasna Malesic, Ptuj (SI); Matija Strlic, Ljubljana (SI); Martin Sala, Domzale (SI); Marijan Kocevar, Ljubljana (SI)

Correspondence Address: HARNESS, DICKEY, & PIERCE, P.L.C, 7700 BONHOMME, STE 400, ST. LOUIS, MO, 63105, US

(73) Assignee: ZFB ZENTRUM FUR BUCHERHALTUNG GMBH, Leipzig (DE)

(21) Appl. No.: 10/572,403

(22) PCT Filed: Sep. 16, 2004
(86) PCT No.: PCT/EP04/10414

§ 371 Date: Feb. 28, 2007

(30) Foreign Application Priority Data
Sep. 16, 2003 (DE) 103 43 047.4

(51) Int. Cl. C09K 15/00

(52) U.S. Cl. 252/397

(57) ABSTRACT

The present invention relates to an antioxidant for an organic material. The invention also relates to the use of the antioxidant for treating an organic material, particularly paper, and to a method for treating the same.

### FIELD OF APPLICATION

The present invention relates to an antioxidant for an organic material. The invention also relates to the use of the antioxidant for treating an organic material, particularly paper, and to a method for treating the same.

### STATE OF THE ART

Cultural treasures, particularly documents and records such as books, files, certificates, maps, drawings etc. are subject to a natural disintegration process, which results in the aging and/or the decay of the corresponding materials. After only 50 to 100 years, for example, the stability of paper may be lowered to such an extent that the paper can no longer be used due to brittleness. Consequently, the inventory of cultural treasures stored, for example, in libraries, archives and museums is acutely at risk.

Great efforts have therefore been put forth to develop methods, which are intended to prevent or slow down the natural disintegration of cultural treasures, particularly of documents and records, and/or to reverse already existing damage from disintegration. It is known that the natural disintegration processes can be attributed substantially to two types of reactions, namely acid hydrolysis and oxidation, which necessitate different treatment strategies.

In the case of acid hydrolysis of cultural treasures such as paper, the cellulose fibers responsible for the paper's stability are broken down hydrolytically by the acids contained in the paper, making the paper brittle. Over the past few years, a series of deacidification methods was developed as paper conservation and restoration measures, in which the acids are neutralized and, where applicable, an alkaline reserve is introduced into the papers for long-term protection. Among other things, also mass deacidifying measures were developed, such as that disclosed in the German patent application DE 199 21 616 A1, which was also filed by the applicant of the present patent and enables the treatment of bound books.

The oxidative disintegration of cultural treasures such as paper means that, in addition to the disintegration process described above by means of acid hydrolisis, the cellulose fibers are disintegrated due to various oxidation reactions, typically radical chain reactions, resulting in yellowing or embrittlement of the wood-containing paper or losses in tear resistance. These oxidation reactions take place in acid and alkaline environments and parallel to the afore-mentioned hydrolysis reactions catalyzed by acid and thus have a synergistic effect on the disintegration of the cultural treasures.

Contrary to the various deacidfying methods, only little is known in the state of the art about methods for the antioxidative treatment of cultural treasures to prevent damage from oxidation. In principle it would be possible to store the organic material in the absence of oxygen, for example in an argon or nitrogen atmosphere. This method, however, is not suited for practical applications because it limits the usability of the material too heavily. Another method known from the prior art is the use of borohydrides, particularly sodium borohydride (NaBH₄), as reducing agents for cellulose damaged from oxidation (oxicellulose) (Sobucki, W., Borhydride—wertvolle Mittel zur Restaurierung von Papier [Borohydrides—valuable means for restoring paper], Restauro, 260-263 (1993); Burgess, H. D., The Stabilization of Cellulosic Fibres by Borhydride Derivatives, ICOM Preprints, 447-452 (1990)). With this method, the oxidatively formed carbonyl and carboxyl groups are reduced again, for example to hydroxyl groups, which crosslink the cellulose fibers among each other by means of intra- and inter-molecular hydrogen bridge bonds and thus are able to stabilize the paper against further disintegration reactions. Additionally, sodium borohydride is alkaline in water and thus leads to a deacidification of the paper at the same time, in addition to the reduction. The combination of deacidifying and reduction treatment is common practice in the aqueous preservation treatment of individual pages, which leads to satisfactory results particularly in papers with severe damage from oxidation (Burgess, supra).

One disadvantage of sodium borohydride, however, is that it is only soluble in water and therefore cannot be used for mass deacidification because only homopolar solvents are suited for this method due to the risks associated with polar solvents, such as the dissolving of adhesives and bleeding of inks. Consequently in practice amino-borane complexes are already used, which are also soluble in homopolar solvents (Bicchierei, M. et al., Restaurator 20. 22 (1999); Bicchieri, M. et al., Restaurator 21, 213-228 (2000)). These amino-borane complexes, however, are nitrogen compounds, which lead to intolerable side effects such as strong odor and yellowing.

### DESCRIPTION OF THE INVENTION

It is therefore the object of the present invention to provide alternative antioxidants for treating organic material, particularly paper, which prevent, slow down or reverse damage due to oxidation reactions and/or acid hydrolysis reactions and do not exhibit the disadvantages mentioned in the prior art.

This object is achieved with the technical method disclosed in claims 1, 10 and 15. Advantageous embodiments are revealed in the dependent claims.

A first aspect of the present invention therefore relates to an antioxidant, which comprises one or more compounds, selected independently from each other from the group comprising complexing agents, UV absorbers/quenchers, radical scavengers, peroxide decomposing agents and reducing agents.

The antioxidant according to the invention is characterized in that it is able to stop, clearly slow or even partially reverse aging-related disintegration processes of organic material, particularly of paper, due to oxidation reactions and/or acid hydrolysis reactions. As a result, the life of the organic materials is prolonged significantly, and thus they are preserved for posterity.

The complexing agents of the inventive antioxidant serve the deactivation of metals, particularly of transition metals, in the organic material, such as paper, in that all coordination sites of the catalyzing metal ions are blocked as a result of complexing, thus eliminating the catalytic effect of the metal ions. In papers produced today, the metals are introduced into the paper during the production process and represent an increasing problem, particularly in recycled paper, where these metal ions accumulate. In old documents and records particularly the ferro-gallic inks are problematic because in addition to the iron (III) tannate they contain excess iron ions, also in the form of Fe²⁺, which destroy the paper by means of oxidation and acid hydrolysis together with the sulfuric acid developing during production (“ink corrosion”).

The complexing agent is preferably selected from the group comprising aminopolycarboxylic acids and polyaminocarboxylates such as methyl imodiacetic acid, ethylene diamine tetraacetic acid, diethylene triamine pentaacetic acid, nitrilotriacetic acid, triethylene tetramine hexaacetic acid, diethyleneglycol diamine ethyl tetraacetic acid, hydroxyethylene diaminotriacetate and N,N-di(hydroxyethyl)glycine; phosphonate such as aminopolyphosphonates/aminotrimethylene phosphonic acid (ATMP), 1-hydroxy-1,1-ethane diphosponic acid (HEDP), aminotris(methylene phosphonic acid) (ATMP), ethylenediamine tetra(methylene phosphonic acid) (EDTMP), diethylenetriaminepenta(methylene phosphonic acid) (DTPMP), hexamethylenediaminetetra(methylene phosphonic acid) (HMDTMP), 2-Phosphonobutane-1,2,4-tricarboxylic acid (PBTC), glucaminebismethylene phosphonic acid, diglucitylethylenediamine bismethylene phosphonic acid; phosphates and polyphosphates such as dipolyphosphate, tripolyphosphate and P64-P70; polyelectrolytes such as polyacrylic acid (PAS), polymaleic acid (PMS), maleic acid methylvinylether copolymer/poly-[(4-methoxy)-tetramethylene-1,2-dicarboxylic acid]maleic acid methylvinylether copolymer (CP2), maleic acid-acrylic acid copolymer/poly-(tetramethylene-1,2,4-tricarboxylic acid) maleic acid-acrylic acid copolymer (CP4), polyoxymethyl carboxylic acid/poly-[(3-hydroxymethyl)-hexamethylene-1,3,5-tricarboxylic acid] (POC), poly-(tetramethylene-1,2-dicarboxylic acid) (DMA) and poly-[(3-oxomethyl)-hexamethylene-1,3,5-tricarboxylic acid]; macrocycles such as cyclodextrines, calixarenes and cryptands; polysaccharides and ether derivatives thereof such as cellulose, starch, chitin, galactomannane and ether derivatives thereof; additional complexing agents and/or metal deactivators such as N-salicylidene ethylamine, N,N′-disalicylidene ethylene, triethylene diamine, lecithin, thiadiazole, imidazole and pyrazole derivatives, acetylacetone, phosphoric acid derivatives, silicic acid derivatives, 1,4,8,11-tetra-azacyclotetradecane, 1,4,8,11-tetramethyl-1,4,8,11-tetra-azacyclotetradecane, 1,4,8,11-tetrathiacyclotetradecane, 1,4,7,10-tetraoxa-acyclododecane, 5,1 4-dihydrodibenzo[b,i]-1,4,8,11-tetra-azacyclotetradecane, 1,7,10,16-tetraoxa-4,13-diazacyclo-octadecane and inositol derivatives; hydroxycarboxylates and alkanolamines such as glucoheptomate (2,3,4,5,6,7-hexahydroxyheptanoic acid), tartrate, salicylate and sulfosalicylate, gluconate, citrate, carboxymethyloxymalonate (CMOM), O-(carboxymethyl)-tartronic acid, carboxymethyloxysuccinate (CMOS) and O-(carboxymethyl)-malic acid.

Particularly preferred are phosphonates, phosphoric acid derivatives, polyelectrolytes, macrocycles, silicic acid derivatives and inositol derivatives. Most preferred are inositol derivatives such as D-myo-inositol-1,2,3-triphosphate and D-myo-inositol-1,2,3,5-tetrakisphosphate. According to the present invention the complexing agent is or the complexing agents are present in a concentration of 0.0001% by weight to 15% by weight, particularly in a concentration of 0.01 to 5% by weight.

The UV absorbers/quenchers of the inventive antioxidant serve to protect the organic material from photochemical damage by absorbing this damaging radiation, particularly UV radiation in the wave range of 300 to 400 nm, and converting it into thermal energy. Unlike the UV absorbers, the quenchers do not absorb radiation, but instead dissipate the energy absorbed by chromophores, which prevents further chemical reactions.

The UV absorber/quencher is preferably selected from the group comprising hydroxyphenylbenzotriazoles, hydroxybenzophenones, formamidine, benzylidene camphor, phenolic antioxidants, sterically hindered phenols and sterically hindered amines.

Particularly preferred are sterically hindered phenols such as octadecyl-3-(3,5-di-t-butyl-4-hydroxyphenyl)propionate, octadecyl-3,5-di-t-butyl-4-hydroxyhydrocinnamate, triethyleneglycolbis[3,3-t-butyl-4-hydroxy-5-methylphenyl)propionate], 1,6-hexanediolbis[3-(3,5-di-t-butyl-4-hydroxyphenylpropionates, N,N′-trimethylenebis(3,5-di-t-butyl-4-hydroxyhydrocinnamide), N,N-hexamethylenebis(3,5-di-t-butyl-4-hydroxyhydrocinnamide), 2,2′-thiodiethylenebis[3-(3,5-di-t-butyl-4-hydroxyphenyl)propionate], thiodiethylenebis-(3,5-di-t-butyl-4-hydroxy)hydrocinnamate, 2,4-bis(n-octylthio)-6-(4-hydroxy-3,5-di-t-butylanilino)-1,3,5-triazine, 2,2′-thiobis(4-methyl-6-t-butylphenol), 1,3,5-trimethyl-2,4,6-tri(3,5-di-t-butyl-4-hydroxybenzyl)benzene, 1,3,5-tri(3,5-di-t-butyl-4-hydroxybenzyl)isocyanurate, pentaerythrityl tetrakis[3-(3,5-di-t-butyl-4-hydroxyphenyl)propionate], diethylesters of 3,5-di-t-butyl-4-hydroxybenzylphosphonic acid, calciumbis(3,5-di-t-butyl-4-hydroxybenzylmonoethyl phosphates), dilauryl thiodipropionate, distearyl thiodipropionate, phenol, 2,4-bis(1,1-dimethylethyl), phosphites (3:1), phosphonous acid, [1,1′-biphenyl]-4,4′-diylbis-tetrakis(2,4,-bis(1,1-dimethylethyl)phenyl]ester; or sterically hindered amines such as sebacic acid-bis-2,2,6,6-tetramethyl-4-piperidyl ester), poly-(N-β-hydroxyethyl-2,2,6,6-tetramethyl-4-hydroxypiperidine)succinic acid ester).

Additional preferred UV absorbers/quenchers are 3,3′-di-t-butyl-2,2′-dihydroxy-5,5′-dimethyldiphenylmethane, 5,5′-di-t-butyl-4,4′-dihydroxydimethyldiphenylsulphides, 3,3′-di-t-butyl-2,2′-dihydroxy-5,5′-diethyldiphenylmethane, 3,3′-di(methylcyclohexyl)-2,2′-dihydroxy-5,5′-dimethyldiphenylmethane, 3,5,3′,5′-tetra-t-butyl-4,4-dihydroxydiphenylmethane, octadecyl-3-(3,5-di-t-butyl-4-hydroxyphenyl)propionates, 1,1,3-tri(2-t-butyl-4-hydroxy-6-methylphenyl)butane, 2,2′-thiodiethylenebis[3-(3,5-di-t-butyl-4-hydroxyphenyl)propionate], 1,3,5-tri(3,5-di-t-butyl-4-hydroxy)-benzyl-2,4,6-trimethylbenzene, pentaerythrityltetrakis[3-(3,5-di-t-butyl-4-hydroxyphenyl)propionates], didodecanyl 3,3′-thiobispropanoate, dioctadecanyl-3,3′-thiobispropanoate, 2-(2-hydroxy-3,5-di-t-butylphenyl)-5-chlorine-2H-benzotriazole.

According to the present invention, the UV absorber/quencher is or the UV absorbers/quenchers are present in a concentration from 0.0001% by weight to 5% by weight, particularly in a concentration of 0.01 to 2% by weight, particularly preferred in a concentration of 0.01 to 1% by weight.

The radical scavenger of the inventive antioxidant unfolds its antioxidative effect by attaching to the active end of the radical, thus deactivating the radical and preventing it from triggering further radical chain reactions. The radical scavenger is preferably selected from the group comprising phenol derivatives such as mono-, di- and polyphenols, aromatic amines, alkylated diphenyl amines, dihydroquinoline derivatives, divalent sulfur derivatives such as dialkyl esters of thiodipropionic acids, trivalent phosphorus compounds. Particularly preferred are secondary aromatic amines such as p-phenylene diamine and diphenylamine and trivalent phosphorus compounds, which have the special advantage that they generally do not result in discoloration.

Particularly preferred radical scavengers are phenol derivatives such as alkyl phenols; hydroxyphenylpropionates such as octadecyl-3-(3,5-di-t-butyl-4-hydroxyphenyl)-propionate, pentaerythrityl-tetrakis-3-(3,5-di-t-butyl-4-hydroxyphenyl)-propionate); hydroxybenzyl compounds such as 3,5-tris-(3,5-di-t-butyl-4-hydroxybenzyl)-mesitylene, calcium-bis[(ethyl-(3,5-di-t-butyl-4-hydroxybenzyl)phosphate], 1,3,5-tris-(4′-t-butyl-5-hydroxy-2′,6′-dimethylbenzyl)-isocyanurate, 1,3,5-tris-(3,5-di-t-butyl-4-hydroxybenzyl)-isocyanurate); alkylidene bisphenols such as 1,1,3-tris-(5-t-butyl-4-hydroxy-2-methylphenyl)-butane, ethylenglycol-bis[3,3-bis(3′-t-butyl-4′-hydroxyphenyl)-butyrate]); thiobisphenols; aminophenols; condensation products from 4,4′-thio-bis(2-t-butyl-5-methylphenol); butylhydroxyanisole; butylhydroxytoluene; gallic acid; alkyl gallates; ascorbic acid and their salts and derivatives, calcium ascorbate; ascorbyl palmitate; isoascorbic acid and their salts and derivatives; 2,6-di-tert-butyl-4-methylphenol, pentaerythrityl-tetrakis-(2,6-di-t-butyl-4-hydroxyphenyl-propionate).

According to the present invention, the radical scavenger is, or where applicable the radical scavengers are, present in a concentration from 0.0001% by weight to 5% by weight, preferably in a concentration of 0.001 to 2% by weight, particularly preferred in a concentration of 0.01 to 1% by weight.

The peroxide decomposing agent of the antioxidant according to the invention inhibits oxidation by breaking down peroxides into the corresponding alcohols. The peroxide decomposing agent is preferably selected from the group comprising halides such as F, Cl, Br and I, pseudohalides such as cyanide, thiocyanate (rhodanide), cyanate and azide, and enzymes such as peroxidases. Particularly preferred are the halides bromide and iodide and the pseudohalides cyanide, thiocyanate (rhodanide), cyanate and azide. The halides and pseudohalides are preferably used in the form of their zinc, alkali, earth alkali or tetraalkyl ammonium salts. According to the present invention, the peroxide decomposing agent is, or where applicable the peroxide decomposing agents are, present in a concentration from 0.0001% by weight to 5% by weight, preferably in a concentration of 0.001 to 2% by weight, particularly preferred in a concentration of 0.01 to 1% by weight.

Within the framework of the present invention, it is also possible to employ “stoichiometric” peroxide decomposing agents, which react with the peroxides while oxidizing their own molecule. Antioxidants of this group contain sulfur, for example thioether, β,β′-thiodipropionic acid dilauryl ester, β,β′-thiodipropionic acid distearyl ester) and/or phosphorus in lower valencies, for example organic phosphites, triphenylphosphine, diethylphosphite, triphenylphosphite, tris-nonylphenylphosphate, tris-(mono/dinonylphenyl)-phosphite, tridecylphosphite, tri-isodecylphosphite, tri-dodecylphosphite, octyl-diphenylphosphite, isooctyl-diphenylphosphite, decyl-diphenylphosphite, isodecyl-diphenylphosphite, didecyl-phenylphosphite, diisodecyl-phenylphosphite, 3,5-di-t-butyl-4-hydroxybenzylphosphonic acid diethyl ester, 3,5-di-t-butyl-4-hydroxybenzylphosphonic acid-di-octadecyl ester, various zinc, barium and calcium thiophosphates, tris-(nonylphenyl)-phosphite, distearylpentaerythrite diphosphite, tris-(2,4-di-t-butylphenyl)-phosphite, tetrakis-(2,4-di-t-butylphenyl)-4,4′-biphenylene diphosphonite, tris-(nonylphenyl)-phosphite.

The reducing agent of the inventive antioxidant acts by means of a reduction of cellulose that has already been damaged by oxidation (oxicellulose), which allows for example carbonyl groups to be converted into hydroxyl groups again. This stabilizes the organic material against further disintegration reactions. Typically only few agents can be used as the reducing agent because they should not result in undesirable changes to the organic material, such as a disadvantageous change of the pH value or staining due to bleeding dyes. The bleeding of dyes can be substantially prevented by using homopolar solvents. In such a case, the reducing agent has to be able to be mixed with homopolar solvents. Due to these requirements, many reducing agents cannot be used with sensitive organic materials. The reducing agent is preferably selected from the group comprising hydrogen, reductors, thiocarbamide, hydroxyacetone, borohydrides, boranes, sulfur dioxide, pyrosulfites, dithionites, hydrogen siloxanes and reductive plasma. Hydrogen siloxanes are particularly preferred reducing agents. According to the present invention, the reducing agent is, or where applicable, the reducing agents are present in a concentration from 0.001% by weight to 50% by weight, preferably in a concentration of 0.01 to 10% by weight, particularly preferred in a concentration of 0.01 to 5% by weight.

The hydrogen siloxanes, which are particularly preferred as reducing agents, react primarily with hydroxyl groups of water, alcohols and cellulose and in isolated cases also with amino groups, which results in the formation of nascent hydrogen according to the reaction equation listed below. As a reducing agent, it can reduce carbonyl groups, which developed as a result of aging-related oxidation reactions from hydroxyl groups, back into the corresponding hydroxyl groups, thus allowing the organic material to be stabilized further against additional disintegration reactions.

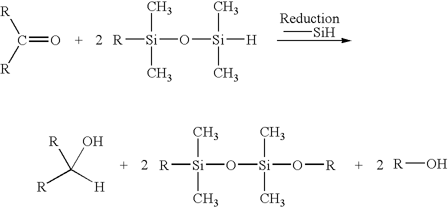

A main advantage of hydrogen siloxanes is that they can be combined without difficulty with the deacidifying agent that is used in the mass deacidification method, such as the Papersave method. This can be attributed to the fact that for example in the Papersave method the deacidifying compound titanium-magnesium-ethanolate (METE) in hexamethyl disiloxane (HMDO) is used as the solvent, with which the hydrogen siloxanes used as the reducing agent can be mixed in any ratio. Another advantage of the hydrogen siloxanes is that these alcohols can be converted into homopolar silanol ethers. This minimizes the bleeding risk of some dyes and inks due to alcohols that develop during the treatment, which are produced particularly during the hydrolysis of certain deacidifying agents.

Silanes or mono-/bifunctional alkyl siloxanes have turned out to be preferred hydrogen siloxanes. Particularly preferred is tetramethyl disiloxane, which is additionally commercially available at a comparatively inexpensive price. Contrary to this, trifunctional or higher functional siloxanes are not suitable for use within the framework of the present invention because under certain circumstances they may form threedimensional cross-linked polymer compounds, which may lead to undesirable side effects.

In a preferred embodiment of the present invention, the inventive antioxidant comprises at least one of the compounds listed in Table 1.

TABLE 1

| mode of | group or product | | | |
|---|---|---|---|---|
| action | name | chemical name | solvent | Conc. |
| Complex. | crown ethers | 18-crown-6 | ethanol | 0.02 M, |
| agent | | | | 0.04M |
| | | 15-crown-5 | ethanol | 0.02 M, |
| | | | | 0.04M |
| | macrocyclic ligands | hexatiacyclooctadecane | nitromethane | 0.33% w/v |
| | | hexaazacyclooctadecane | nitromethane | 0.2% w/v |
| | | | ethanol | 1% w/v |
| | | tetrathiacyclooctadecane | nitromethane | 0.25% w/v |
| | | tetraazacyclooctadecane | nitromethane | |
| | | gallic acid | ethanol | 2% w/v |
| | irgamet 42 | ethanol, 2.2′-((methyl-1H- | ethanol | 1% w/v |
| | | benzotriazol-1- | | |
| | | yk)methyl)imino)bis- | | |
| | dequest 2041 | ethylenediamine tetraphosphonic | ethanol | 0.01M |
| | | acid, tetraethylammonium salt | | |
| | | ethylenediamine tetraphosphonic | water | 0.01M |
| | | acid, sodium salt | | |
| | dequest 2054 | Hexamethylenediamine | water | 0.01M |
| | | tetra(methylene phosphonic acid), | | |
| | | potassium salt | | |
| | dequest 2000 | ATMP, Amino tri (methylene- | water | 0.01M |
| | | phosphonic acid), sodium salt | | |
| | dequest 2060 | Diethylenetriaminepenta(methylenephosphonic | water | 0.01M |
| | | acid), | | |
| | phytate | myo-inositol hexaphosphoric acid, | ethanol | |
| | | tetraetylammonium salt | | |
| | triethylene tetramine | triethylene tetramine | dichloromethane | 1% w/v |
| | desferal | desferrioxamine mesylate | water | 0.02 M |
| | phytate | myo-inositol hexaphosphoric acid, | methanol | |
| | | cyclohexilammonium salt | | |
| | Borchi Nox M2 | 2-butanon oxime | ethanol | 1% w/v |
| | | citosane 85/500/A4 | water | 0.05% w/v |
| | | citosane 90/20/A1 | water | 0.05% w/v |
| | | citosane 90/200/A1 | water | 0.05% w/v |
| | | dextrane 500 | water | 1% w/v |
| | | alginic acid, M: 48-168000 | water | 1% w/v |
| | | carrageenan | water | 1% w/v |
| | Dequest 2016 | Sodium HEDP; 1- | water | 1% w/v |
| | | Hydroxyethylene-1,1,- | | |
| | | diphosphonic acid tetra sodium | | |
| | | salt | | |
| | dequest 2041 | ethylenediamine tetraphosphonic | ethanol | 1% w/v |
| | | acid, hexilammonium salt | | |
| peroxide | iodide | potassium iodide | ethanol | 1% w/v |
| decomp. | | | | |
| | iodide | tetrabutylammonium iodide | dichloromethane | 1% w/v |
| | rhodanide | Potassium thicyanate | water | 0.01M |
| | bromide | sodium bromide | ethanol | 1% w/v |
| | bromide | tetrabutylammonium bromide | dichloromethane | 1% w/v |
| | irgafos 168 | Cyba chem.. | chlorophorm | 100% w/v |
| | Tinogard TL | Cyba chem.. | dichloromethane | 10% w/v |
| radical | irganox 1010 | Pentaaerythrol tetrakis(3-(3,5- | dichloromethane | 10% w/v |
| scavenger | | ditert-butyl-4- | | |
| | | hydroxyphenyl)propionate) | | |
| | | | chlorophorm | 10% w/v |
| mixture | irganox B225 | 50% irgafos 168 and 50% irganox | dichloromethane | 10% w/v |
| | | 1010 | | |
| | | | chlorophorm | 10% w/v |
| | carvedilol | (carbazoloyl-(4)-oxyl)-3-(2- | dichloromethane | 0.15% w/v |
| | | methoxy-phenoxyl)ethylamino-2- | | |
| | | propanol | | |

According to the present invention, particularly preferred antioxidants are combinations of at least two or more compounds from at least two or more categories of antioxidative compounds selected from the group comprising complexing agents, UV absorbers/quenchers, radical scavengers, peroxide decomposing agents and reducing agents. Preferred is, for example, a mixture of radical scavengers and peroxide decomposing agents, which mixture has synergistic effects and protects the organic material to be treated in an excellent fashion from decay and/or disintegration.

Another particularly preferred mixture comprises radical scavengers, peroxide decomposing agents and complexing agents.

In a particularly preferred embodiment of the present invention, the above-mentioned antioxidant additionally comprises one or more deacidifying agents. This offers the advantage that the disintegration process of the organic material can be slowed down to a greater extent that when using one antioxidant or one deacidifying agent alone, that the number of process steps can be decreased and thus costs savings can be achieved. The deacidifying agent is preferably an earth alkali compound. It is particularly preferred if the deacidifying agent is calcium carbonate, calcium alcoholate, carbonized calcium alcoholate, calcium bicarbonate, calcium hydroxide, calcium oxide, magnesium carbonate, magnesium alcoholate, carbonized magnesium alcoholate, magnesium bicarbonate, magnesium hydroxide, magnesium oxide or mixtures thereof. The deacidifying agent is preferably present in a concentration of 0.0001 to 10% by weight, particularly preferred in a concentration of 0.1 to 3% by weight.

According to the present invention, a combination of hydrogen siloxanes, particularly tetramethyl disiloxane, and a deacidifying agent represents another particularly preferred antioxidant.

The antioxidant according to the invention can be present dissolved, dispersed or emulsified in a solvent. Basically all solvents can be used as the solvent in which the inventive antioxidant is dissolved, dispersed or emulsified. Preferred solvents are water, alcohols, hydrocarbons, particularly alkanes and cycloalkanes, silicon-organic compounds such as siloxanes, halogenated hydrocarbons such as fluorinated hydrocarbons, chlorinated hydrocarbons, chlorofluorocarbons, and liquid or supercritical gases, particularly liquid or supercritical carbon dioxide. Homopolar, organic, aprotic solvents such as alkanes, halogenated hydrocarbons or methyl siloxanes have turned out to be particularly preferred solvents because they do not result in smudging of the organic material that is to be treated, particularly documents and records, from bleeding dyes and inks.

The overall concentration of the inventive antioxidant, which is dissolved in one of the afore-mentioned solvents, is preferably selected as low as possible and ranges preferably between 0.0001 and 25% by weight, particularly in the range between 0.001 and 5% by weight, as a function of the organic material to be treated and the employed antioxidant. If the antioxidant according to the invention is present in the form of an aerosol, gas, as dust or a powder, the concentration can range between 0.0001 and 100% by weight.

The antioxidant according to the invention is preferably intended for organic material selected from textile cellulose, silk, wool, leather, parchment, wood, paper, cardboard and materials used for paintings and other pieces of art, however is not limited to these. It is particularly preferred if the organic material is paper, particularly documents and records on paper basis such as books, files, certificates, maps, drawings, posters etc. as well as documents and records on parchment basis.

A second aspect of the present invention relates to a method for treating organic material, in which the organic material is brought in contact with an antioxidant according to the invention.

The method according to the invention is preferably conducted at a temperature of 0 to 100° C. and particularly at 5 to 55° C. It is particularly preferred if the temperature is 15 to 35° C.

Except when using liquid gases and supercritical gases, the pressure preferably ranges from 0.001 to 3 bar. It is particularly preferred if the pressure ranges from 0.1 to 1.5 bar. When using liquid gases and supercritical gases, the pressure can be up to 300 bar.

Additionally it is preferred if the method is conducted in an atmosphere that is free of or low in oxygen. It is particularly preferred if the atmosphere is made of nitrogen, carbon dioxide, noble gas, particularly argon, or a mixture thereof.

The treatment duration of the inventive method is preferably 1 minute to 72 hours, particularly 5 minutes to 24 hours, and particularly preferred 10 minutes to 3 hours.

In another embodiment of the present invention, the organic material is brought in contact with an antioxidant according to the invention, which does not contain a deacidifying agent, wherein the organic material is treated with one or more deacidifying agents prior to or following the contact.

Prior to or following the treatment with the inventive antioxidant with or without one or several additional deacidifying agents, the organic material may also be treated in a different manner, where applicable, for example it can be cleaned, stabilized, fixed etc.

The antioxidants can be applied onto and into the organic material to be treated in a solid state such as in the form of a powder or dust, in a liquid state such as in the form of solutions in polar or homopolar solvents and supercritical gases, particularly supercritical carbon dioxide, dispersions, emulsions and suspensions, or in a gaseous state such as in the form of gases and aerosols. Possible solvents are the afore-mentioned solvents.

The underlying antioxidant of the method according to the invention can be applied onto the organic material that is to be treated by means of various application methods as a function of the material to be treated. To this end, in the case of a solid application/introduction, spraying by means of a nozzle, absorption by means of a vacuum, application by means of brushes, sponges and compresses and technical methods that are used to introduce powders and dust may be employed. In the case of a liquid application/introduction, preferably a saturating method, particularly vacuum impregnation, spraying/misting, or the application by means of brushes, sponges or compresses are suited. In the case of a gaseous application/introduction, preferably a gasing method or the application of aerosols by means of nozzles and other suitable technical devices is employed.

The organic material according to the invention is preferably selected from textile cellulose, silk, wool, leather, parchment, wood, paper, cardboard and materials used for paintings and other pieces of art, however is not limited to these. It is particularly preferred if the organic material is paper, particularly documents and records on paper basis such as books, files, certificates, map, drawings, posters etc. as well as documents and records on parchment basis.

A third aspect of the present invention relates to the use of the antioxidant according to the invention for treating organic material, particularly organic material selected from textile cellulose, silk, wool, leather, parchment, wood, paper, cardboard and materials used for paintings and other pieces of art, with paper, particularly documents and records on paper basis such as books, files, certificates, maps, drawings, posters etc., as well as documents and records on perchment basis being particularly preferred.

The present invention will be explained in more detail hereinafter with reference to the examples of preferred embodiments illustrated in FIG. 1 to FIG. 9.

### FIGURES

FIG. 1 shows the results of Example 1.

FIG. 2 and FIG. 3 show the results of Example 2.

FIGS. 4, 5 and 6 show the results of Example 3.

FIG. 7 shows the results of Example 4.

FIG. 8 illustrates the structures of the inositol derivatives MS-22 and MS-23.

FIG. 9 shows the results of Example 5.

### EXAMPLES

### Example 1

### Use of Halides and Pseudohalides for Oxidation Inhibition

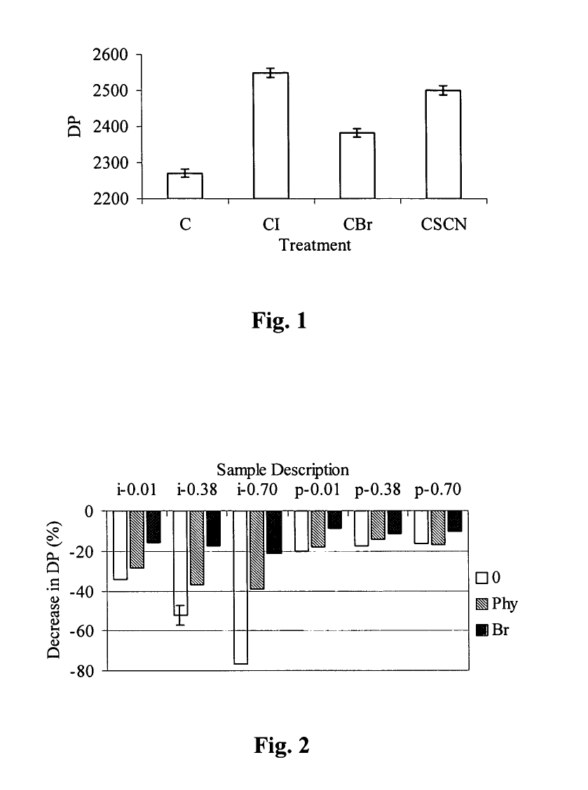

This example was conducted to study the inhibiting effect of the halides potassium iodide (KI) and sodium bromide (NaBr) as well as of the pseudohalide potassium rhodanide (KSCN), which act as peroxide decomposing agents, on the aging of deacidified cellulose in an alkaline environment. The experiments were conducted with Whatman filter paper no. 1 (86.0 g/m², degree of polymerization (DP): 2630). Following deacidification using a 0.01 M aqueous solution made of Ca(HCO₃)₂, the samples were dried and immersed for 5 minutes in an aqueous antioxidant solution (KI, NaBr, KSCN). Then these samples were artificially aged for 48 days in a Votsch VC 0020 climate chamber at a temperature of 80° C. and a relative humidity of 65%. The results are illustrated in FIG. 1, with C representing the degree of polymerization (DP) following the deacidification with Ca(HCO₃)₂, and Cl, CBr as well as CSCN representing the degree of polymerization following the treatment with the antioxidants KI, NaBr and/or KSCN. The error bars mark the standard deviation.

FIG. 1 shows that each of the three employed antioxidants results in improved stability following aging in the sequence I⁻>SCN⁻>Br⁻. Hence, effective stabilization can be achieved in an alkaline environment through the treatment with halides such as Cl and Br and pseudohalides such as SCN.

### Example 2

### Effectiveness of Halides compared to Existing Phytates, Decrease of the Degree of Polymerization and Brightness L* following Aging

The experiment serves to compare the effectiveness of halides with that of phytates. This is demonstrated as a function of the degree of polymerization and brightness of the ink composition following aging. For this purpose, three exemplary ferro-gallic inks having a Cu:Fe molar ratio of 0.01, 0.38 and 0.70 were applied on select paper. The samples produced this way were either deacidified (C) with calcium hydrogen carbonate alone or additionally treated antioxidatively using a combination of calcium hydrogen carbonate and calcium ammonium phytate (Phy). The samples using bromide (Br) were obtained by impregnating only deacidified papers in another step using a 1% aqueous tetrabutyl ammonium bromide solution.

The degrees of polymerization shown in FIG. 2 following the deacidification, antioxidative treatment and 12 days of dynamic aging of paper containing ink (i-) and surrounding ink (p-) demonstrate that phytate stabilizes inks, which in addition to iron also contain considerable amounts of other transition metal ions. Consequently, phytate can be used for the aqueous stabilization of historic inks. The results described above, however, particularly prove the excellent stabilization that is achieved following the use of bromide compared to the use of the existing combination of deacidification and treatment with phytate. Additionally the DP of paper surrounding the ink was determined. In this respect as well it could be demonstrated that bromide results in a clear improvement in stability. These results are insofar important that aqueous treatments offer the possibility of transition metal ions migrating into adjoining regions.

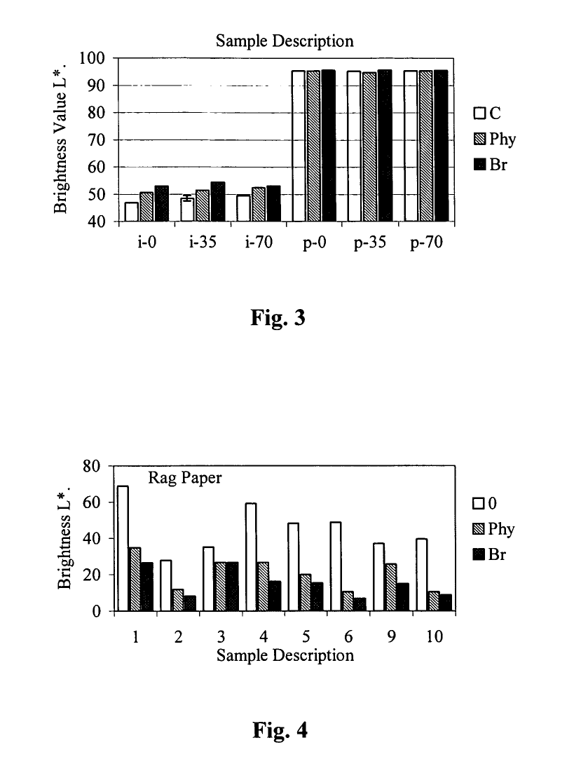

In the evaluation of the suitability of bromides for stabilizing historic papers, their effects on the colors of the ink and paper is particularly important. The results of such a study are therefore illustrated in FIG. 3. In order to observe the effects, the decrease in the brightness L* of the CIE L*a*b* color system following 12 days of dynamic aging of paper containing ink (i-) and surrounding ink (p-) was used. The deacidifying step was performed by means of impregnation in a Ca(HCO₃)₂ solution. Papers without antioxidants (C) were compared to a treatment with phytate (Phy) and bromide (Br).

While the untreated sample slightly lost some brightness following aging (L* prior to aging=49.1), the samples were slightly brighter as a result of the phytate and bromide treatments. The evaluation of the paper surrounding the ink, however, produced no significant differences.

### Example 3

### Effectiveness of Halides compared to Existing Phytates on the Basis of Originals, Decrease in the Brightness Value L* following Dynamic Aging

Several originals consisting of rag paper having different origins, which were all written on with ferro-gallic ink, were aged for 123 days under dynamic conditions (90° C., RH 30-80%). The samples were either left untreated (O), treated antioxidatively with phytate (Phy) or deacidified with calcium carbonate and then treated antioxidatively with tetrabutyl ammonium bromide.

Following the aging process, the decrease in brightness L* (CIE L*a*b* color system) of the paper (without ink) was measured as a function of the treatment (FIG. 4). In all 10 samples, a decrease in the brightness value L* was observed in the sequence 0>Phy>Br. When bromide was used instead of phytate, even a considerable decrease in brightness was noticed in some papers.

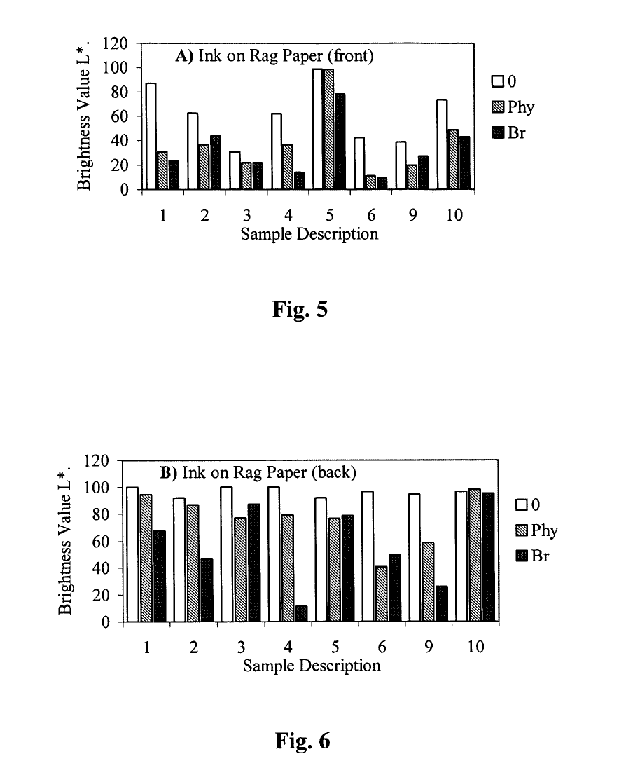

The decrease in brightness L* was also measured in the areas of the aged originals on which ink had been used. Here a differentiation was made between the front A) of the page to which ink was applied and the back B) of the page, on which nothing had been written and the ink only showed through. The results of these studies are illustrated in FIG. 5 and FIG. 6, with the measurement of L* on the front being of particular significance as an indicator of the overall condition of the object.

A comparison of the measurements shows that most inks behave the same as the papers and that the decrease in brightness as a result of the treatment results in the same sequence (O>Phy>Br). Some inks that were treated with bromide likewise exhibited a significantly smaller decrease in L* than those treated with phytate. Unlike the afore-mentioned rag paper, however, also a slight decrease in L* following the treatment with bromide was observed with some inks.

### Example 4

### Combining Deacidification with the Application of an Antioxidant and Comparison of the same to Untreated and Deacidified Samples, each without antioxidative Treatment, Decrease of the Degree of Polymerization following Dynamic Aging

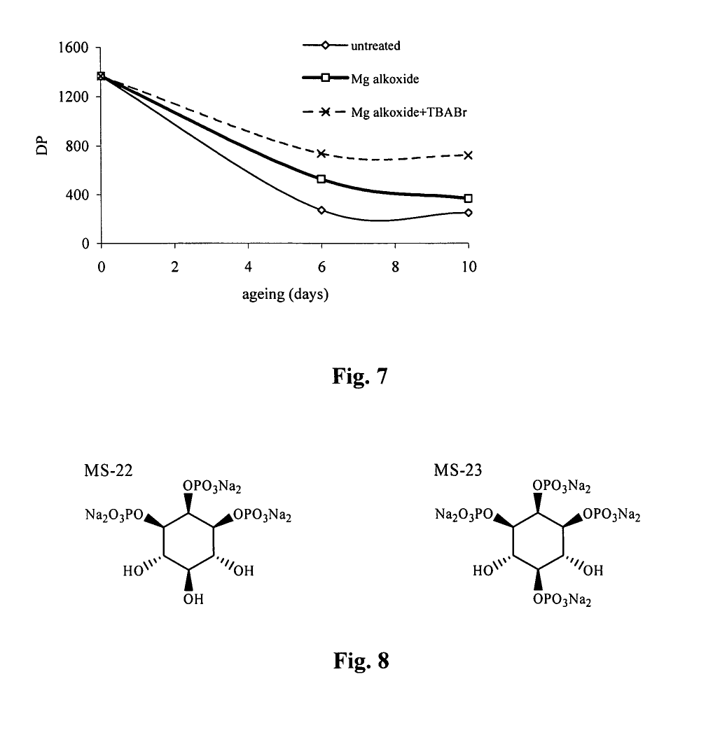

In the studies conducted so far, the stabilizing effect of the bromides was demonstrated as long as they were applied in an aqueous solution. This example is therefore intended to demonstrate the use of halides and pseudohalides in a homopolar solution, particularly since this type of application is crucial when combining it with modern deacidifying methods. For this reason, select papers were deacidified with 0.01 M magnesium alkoxide in ethanol and some of these papers were then treated with a 1% w/v solution of tetrabutyl ammonium bromide in methylene chloride. To illustrate the stabilizing effect, the DP of such a sample was compared to that of an untreated sample and that of a deacidified sample without antioxidative treatment following aging. The dynamic aging process (90° C., RH 30-80%) was conducted for up to 10 days; the results are shown in FIG. 7.

They illustrate that combining deacidification with an antioxidative treatment allows excellent results to be achieved when it comes to the stabilization of papers damaged by ink corrosion.

### Example 5

### Stabilizing Effect of Novel, Synthetic Inositol Derivatives

To expand the phytates having a stabilizing effect in aqeous treatments, further derivatives were synthesized starting with myo-inositol. Unlike phytates, which are only soluble in water, they are also soluble in homopolar solvents and can therefore also be employed in modern stabilization methods. In this example the effects of D-myo-inositol-1,2,3-triphosphate (MS-22) and D-myo-inositol-1,2,3,5-tetrakisphosphate (MS-23) will be described representatively for the myo-inositol derivatives.

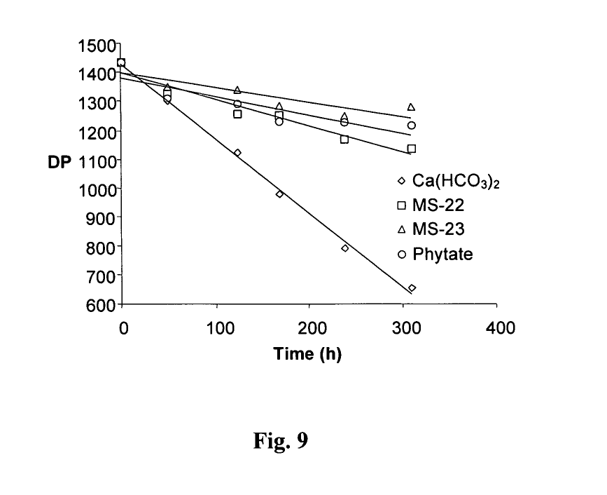

The papers, which were deacidified twice for 30 minutes each with 0.01 M calcium hydrogen carbonate, were either saturated without further treatment or saturated for 2×15 minutes in 1.4×10⁻² M aqueous solutions of phytate, MS-22 or MS-23. Thereafter all samples were aged for up to 310 hours. As is shown in FIG. 9, the myo-inositol derivatives exhibit a similar activity in these studies as the phytates. Consequently, a high stabilizing effect is also achieved with these novel compounds. Since these derivatives, however, can also be used in homopolar solvents, they field of application is significantly greater than that of phytate.

### Example 6

### Use of Tetramethyl Disiloxane in Conjunction with a Deacidifying Agent for the Reductive Treatment and Deacidification of acid Paper damaged by Oxidation

In the following experiments, a newspaper that was already significantly damaged as a result of natural aging was used (Handelsblatt from the year 1954). The newspaper was treated with a pilot system using the familiar Papersave method, however only 1% by weight of tetramethyl disiloxane was added to the deacidifying solution. The concact time of the treatment solution with the organic material to be treated was extended beyond the typical 30 minutes used with the deacidification step of the Papersave method to 5 hours. The effect of the treatment was determined by means of a 90-day artificial aging process (80° C./65% relative humidity) with the help of tear resistance measurements (tensile strength in Newton (N)). The tear resistance of the deacidified paper treated with tetramethyl disiloxane was compared to the tear resistance values of untreated and deacidified papers. The results are shown in Table 2.

TABLE 2

| | Tear Resistance following |
|---|---|
| | 90 Days of Aging [N] |
| Untreated paper | 14.0 |
| Deacidified paper | 23.4 |
| Deacidified paper treated with tetramethyl | 31.8 |
| disiloxane | |

The data summarized in Table 2 shows that the stability gained from deacidification can be significantly improved with a simultaneous reductive treatment using tetramethyl disiloxane.

1. An antioxidant for an organic material, characterized in that the antioxidant comprises one or more compounds independently selected from the group consisting of complexing agents, UV absorbers/quenchers, radical scavengers, peroxide decomposing agents, and reducing agents.

2. An antioxidant for an organic material according to claim 1, characterized in that the complexing agent is selected from the group consisting of aminopolycarboxylic acids, polyaminocarboxylates, phosponates, phosphates, polyphosphates, polyelectrolytes, macrocycles, polysaccharides, ether derivatives of polvsaccharides, hydroxycarboxylates, alkanol amines, N-salicylidene ethyl amine, N,N′-disalicylidene ethylene, triethylene diamine, lecithin, thiadiazole, imidazole derivatives, pyrazole derivatives, phosphoric acid derivatives, silicic acid derivatives, and inositol derivatives.

3. An antioxidant for an organic material according to claim 1, characterized in that the UV absorber/quencher is selected from the group consisting of hydroxyphenylbenzotriazoles, hydroxybenzophenones, formamidine, benzylidene camphor, phenolic antioxidants, sterically hindered phenols, and sterically hindered amines.

4. An antioxidant for an organic material according to claim 1, characterized in that the radical scavenger is selected from the group consisting of phenol derivatives, aromatic amines, alkylated diphenyl amines, dihydroquinoline derivatives, divalent sulfur derivatives, and trivalent phosphorus compounds.

5. An antioxidant for an organic material according to claim 1, characterized in that the peroxide decomposing agent is selected from the group consisting of halides, pseudohalides, and enzymes.

6. An antioxidant for an organic material according to claim 1, characterized in that the reducing agent is selected from the group consisting of hydrogen, reductors, thiocarbamide, hydroxyacetone, borohydrides, boranes, sulfur dioxide, pyrosulfites, dithionites, hydrogen siloxanes, and reductive plasma.

7. An antioxidant for an organic material according to claim 1, characterized in that the antioxidant additionally comprises one or more deacidifying agents.

8. An antioxidant for an organic material according to claim 7, characterized in that the deacidifying agent comprises an earth alkali compound.

9. An antioxidant for an organic material according to claim 1, characterized in that the organic material is paper.

10. A method for treating organic material, characterized in that the organic material is brought in contact with an antioxidant according to claim 1 for 1 minute to 72 hours at a temperature of 0 to 100° C. at pressure of 0.001 to 300 bar in an atmosphere that is low in oxygen.

11. A method for treating organic material according to claim 10, characterized in that the organic material is treated with one or more deacidifying agents prior to or following the contact with an antioxidant.

12. A method for treating organic material according to claim 11, characterized in that the deacidifying agent comprises an earth alkali compound.

13. A method for treating organic material according to claim 10, characterized in that the organic material is paper.

14. A method for treating organic material according to claim 10, characterized in that the organic material consists of documents and records.

15. (canceled)

16. (canceled)

17. A method for preventing, slowing down, and/or reversing damage in an organic material due to oxidation and/or hydrolysis reactions, wherein the method comprises treating the organic material for about 1 minute to about 72 hours at a temperature of about 0 to about 100° C. at pressure of about 0.001 to about 300 bar in an atmosphere that is low in oxygen with an the antioxidant comprising one or more compounds independently selected from the group consisting of complexing agents, UV absorbers/quenchers, radical scavengers, peroxide decomposing agents, and reducing agents.

18. A method according to claim 17, wherein the method further comprises treating the organic material with one or more deacidifying agents prior to or following the treatment with an antioxidant.

19. A method according to claim 17, wherein the organic material is paper.

20. A method according to claim 17, wherein the complexing agent is selected from the group consisting of aminopolycarboxylic acids, polyaminocarboxylates, phosponates, phosphates, polyphosphates, polyelectrolytes, macrocycles, polysaccharides, ether derivatives of polysaccharides, hydroxycarboxylates, alkanol amines, N-salicylidene ethyl amine, N,N′-disalicylidene ethylene, triethylene diamine, lecithin, thiadiazole, imidazole derivatives, pyrazole derivatives, phosphoric acid derivatives, silicic acid derivatives, and inositol derivatives.

21. A method according to claim 17, wherein the peroxide decomposing agent is selected from the group consisting of halides, pseudohalides, and enzymes.

22. A method according to claim 17, wherein the reducing agent is selected from the group consisting of hydrogen, reductors, thiocarbamide, hydroxyacetone, borohydrides, boranes, sulfur dioxide, pyrosulfites, dithionites, hydrogen siloxanes, and reductive plasma.
